(19) United States
(12) Patent Application Publication
(10) Pub. No.: US 2014/0189667 A1
(43) Pub. Date: Jul. 3, 2014

(54) SPECULATIVE MEMORY DISAMBIGUATION ANALYSIS AND OPTIMIZATION WITH HARDWARE SUPPORT

(71) Applicants: Abhay S. Kanhere, Fremont, CA (US); Suriya Subramanian, Sunnyvale, CA (US); Saurabh S. Shukla, Santa Clara, CA (US)

(72) Inventors: Abhay S. Kanhere, Fremont, CA (US); Suriya Subramanian, Sunnyvale, CA (US); Saurabh S. Shukla, Santa Clara, CA (US)

(21) Appl. No.: 13/730,916

(22) Filed: Dec. 29, 2012

(51) Int. Cl. G06F 9/45

(52) U.S. Cl. CPC G06F 8/443
USPC 717/160; 717/159

(57) ABSTRACT

Methods and apparatus to provide speculative memory disambiguation analysis and optimization with hardware support are described. In one embodiment, input code is analyzed to determine one or more memory locations to be accessed by the input program and output code is generated based on the input code and one or more assumptions about invariance of the one or more memory locations. The output code is generated also based on hardware transactional memory support and hardware dynamic disambiguation support. Other embodiments are also described.

### FIELD

The present disclosure generally relates to the field of computing. More particularly, an embodiment of the invention generally relates to speculative memory disambiguation analysis and optimization with hardware support.

### BACKGROUND

In modern processors, instructions may be executed out-of-order to improve performance. More specifically, out-of-order execution provides instruction-level parallelism which can significantly speed up computing. To provide correctness for out-of-order execution, memory disambiguation may be used. Memory disambiguation generally refers to a technique that allows for execution of memory access instructions (e.g., loads and stores) out of program order. The mechanisms for performing memory disambiguation can detect true dependencies between memory operations (e.g., at execution time) and allow a processor to recover when a dependence has been violated. Memory disambiguation may also eliminate spurious memory dependencies and allow for greater instruction-level parallelism by allowing safe out-of-order execution of load and store operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-6 illustrate sample pseudo codes according to some embodiments.

FIGS. 7 and 8 illustrate block diagrams of embodiments of computing systems, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software (including for example micro-code that controls the operations of a processor, firmware, etc.), or some combination thereof. Also, as discussed herein, the terms “hardware” and “logic” are interchangeable.

Some embodiments discussed herein may provide speculative memory disambiguation analysis and/or optimization with hardware support. The inability to assert the invariance of a memory location inhibits various compiler optimizations, be it in a classic compiler analyzing ambiguous memory references in source code or a dynamic binary translation system analyzing memory references in a region of machine code. To this end, some embodiments analyze the input program aggressively and generate code with assumptions about the invariance of memory locations. Such an approach allows for leveraging: (1) hardware support for transactional memory; and (2) hardware support for dynamic disambiguation (e.g., to verify these assertions/assumptions at runtime). As a result, the number of loops that a loop optimizer or more generally an “optimizer” (which may also be referred to herein interchangeably as “optimizer logic”) can optimize for better performance can be increased. Without such embodiments, an optimizer will be forced to either generate poor performing code or not optimize the loop at all. Furthermore, code optimizers that cannot efficiently disambiguate certain memory accesses are precluded from performing certain optimizations.

Generally, a memory access read or write is considered ambiguous when a code optimizer (such as a compiler, Just-In-Time (JIT) compiler, or a binary translator) is unable to guarantee that no other code or program can write to the memory location of the access. When an input code being optimized contains ambiguous memory accesses, the optimizer usually generates very poor code. By contrast, in an embodiment, a code optimizer logic is provided that works in the context of a binary optimizer. As discussed herein, optimizing may be performed on a loop or a loop-nest. Some embodiments provide one or more (e.g., adjacent) loop iterations within a Restricted Transactional Memory (RTM) region, where an entire loop may execute in multiple back to back or adjacent RTM regions. Since RTM regions may have size restrictions (e.g., hardware supports limited size), a single RTM region may not enclose all iterations of a given loop.

In one embodiment, optimizer logic requires the invariance of ambiguous memory accesses across some or all iterations of a loop and the optimizer adds a few minimal checks in the code it generates and relies on: (1) hardware support for transactional memory (such as Transactional Synchronization Extensions (TSX)) to ensure individual loop iterations are executed atomically; and (2) hardware support for dynamic disambiguation to verify these checks within a transactional system at runtime. If any check fails then the atomic region rollbacks and an alternate code path without the optimization is executed. This ensures forward progress.

In various embodiments, hardware support is provided to provide the following two features:

(1) Hardware Transactional Memory (HTM) or Restricted Transactional Memory (RTM): HTM (such as TSX) generally allows for atomic execution of code (also called a transaction). A system with HTM executes this region of code in a single atomic operation. HTM takes care to ensure that no other thread or program in the system writes to the same physical memory as this transaction. By using HTM, the invariance of interested memory locations is protected from other threads, but this does not protect against modifications within the region.

(2) Hardware memory disambiguation support: code is generated that issues checks to a runtime memory disambiguation hardware. The hardware ensures that no other instructions in the region can write to marked memory locations that are of interest. Such disambiguation hardware protects the invariance of interested memory locations from other writes in the same thread within the scope of an RTM region.

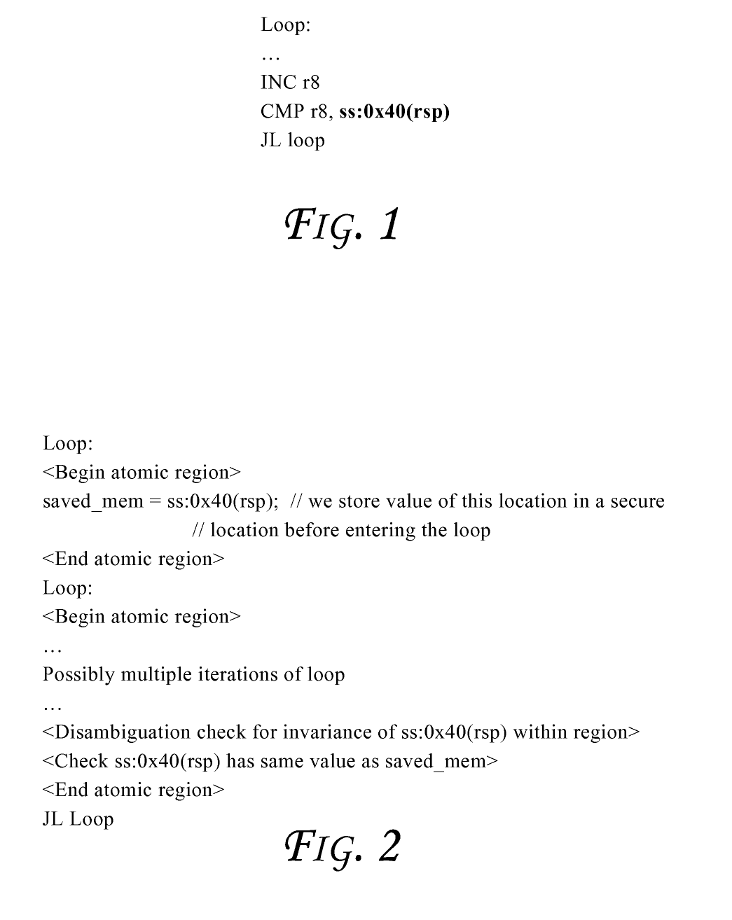

FIGS. 1-6 illustrate sample code relating to loop iterations, according to some embodiments. For example, several types of assumptions are shown that the loop optimizer logic can make about the invariance of memory accesses across some or all loop iterations. For each example, the input code and the code that optimizer would generate are presented in successive figures as will be discussed in more detail below.

Referring to FIG. 1, sample loop code for the assertion or assumption that the limit of a loop is invariant is shown, where INC stands for an increment operation, CMP refers to a compare operation, r8 (or more generally r# refers to register number #) refers to a register, and JL which stands for Jump-if-Less marks the end of a loop. ss:0x40(rsp) refers to a memory location using the Intel® 64 or IA-32 instruction syntax where ss stands for the stack segment register and rsp stands for the stack pointer register. FIG. 2 illustrates the code that the optimizer logic would generate for the loop of FIG. 1. As can be seen, multiple iterations of the input loop are combined into a single atomic region asserting that the value residing at ss:0x40(rsp) is unchanged within the atomic region and across multiple atomic regions. For example, for a loop with 100 iterations, we could combine 4 adjacent iterations within one atomic region. Complete execution of the loop requires retiring 100/4 or 25 atomic regions. The invariance of this memory location is ensured using the following checks in some embodiments:

1. RTM protects against changes to this memory region from other thread(s) or DMA (Direct Memory Access).

2. Disambiguation checks ensure code enclosed within the RTM region does not modify this location.

3. The value of the memory location is saved and each atomic region checks the value of the memory location with this saved value.

If any check fails, then the RTM region rollbacks and an alternate code path without this optimization is executed in an embodiment. Furthermore, the loop optimizer can generate better code for computing loop trip count before loop execution even though initial, final, or step values are memory accesses. At runtime, if these memory references change, this change may be detected and alternate execution path is followed for future iterations of this loop.

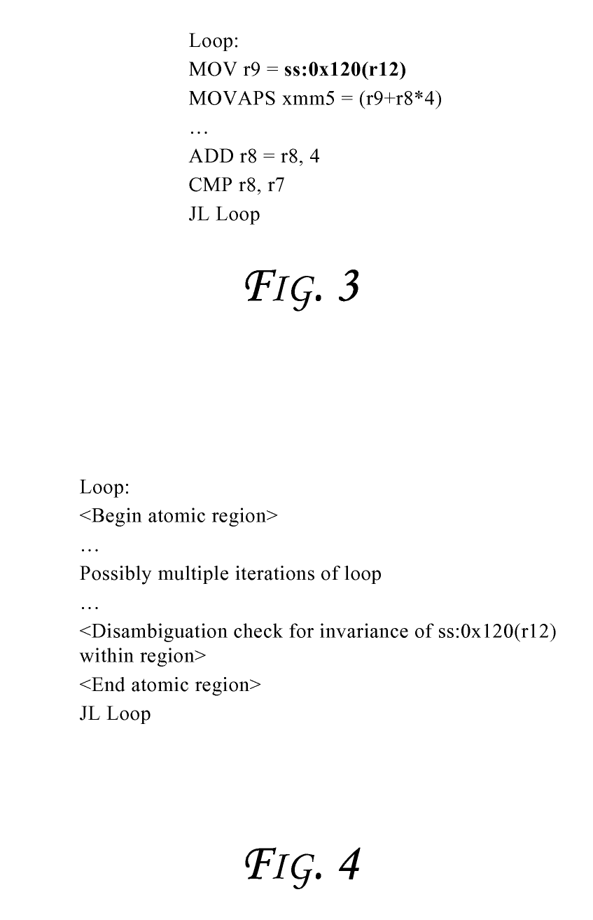

Referring to FIG. 3, sample loop code for the assertion or assumption that base address of a memory access is invariant is shown, where MOV stands for a move operation, MOVAPS stands for move aligned packed single-precision floating point, and ADD refers to an add operation. In some embodiments, indirect addressing using loads is performed and invariance of the corresponding memory location is asserted. For example, global variables are accessed through a GOT (Global Offset Table) and these indirections are setup by dynamic linker and do not change during execution. One embodiment allows such variables to be treated as loop invariant by the loop optimizer logic and any violations of this invariance are correctly detected at runtime. FIG. 4 illustrates the code that the optimizer logic would generate for the loop of FIG. 3, e.g., based on an assertion/assumption that ss:0x120(r12) is invariant.

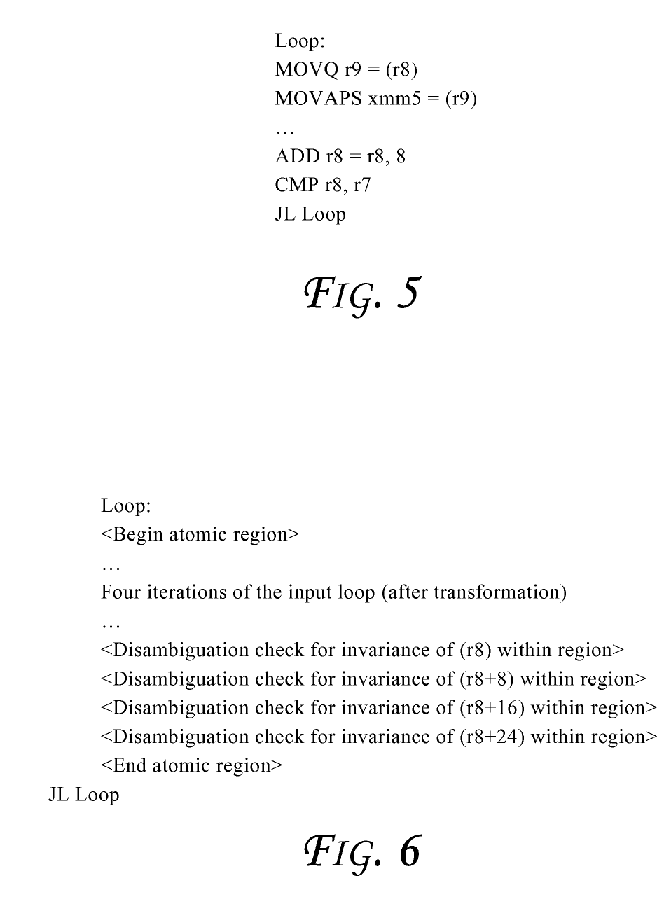

Referring to FIG. 5, sample loop code for the assertion or assumption that memory locations used in indirections are invariant within the RTM region is shown, where MOVQ refers to a move quadword operation. FIG. 6 illustrates the code that the optimizer logic would generate for the loop of FIG. 5. Sometimes indirect memory accesses are inductive. For example, a global array is accessed within a loop such as A(B(i)) where i is an induction variable, and we want to assert that B(i), B(i+1), . . . B(i+k) are not changing within the RTM region. In an embodiment, the disambiguation hardware ensures this condition.

As shown in FIG. 5, r8 changes at every iteration. As a result, different memory locations are accessed in successive iterations. A transformation may be performed where four iterations of the input loop are combined into one (as indicated in FIG. 6). In such a transformation, the goal is to assert that the four locations (r8), (r8+8), (r8+16), and (r8+24) are invariant across the combined iteration.

As discussed with reference to FIGS. 1-6, some embodiments rely on hardware transactional memory support and hardware memory disambiguation support with limited scope (e.g., within an atomic region) to assume invariance of ambiguous memory references and perform aggressive optimizations when such an opportunity was not available earlier. Hence, the combination of HTM and hardware memory disambiguation along with co-designed software checks can achieve stronger result(s) (e.g., invariance of memory reference(s) across multiple back to back atomic regions, as long as disambiguation is with an atomic region).

Furthermore, some systems may have special hardware support to check for invariance of memory locations at memory controller level. That approach does not scale across multiple memory controllers and multiple logical cores. By contrast, some embodiments use two pieces of hardware support, RTM and dynamic memory disambiguation hardware, which may be combined with software checks to achieve invariance checks. Also, some processors may provide ALAT (Advanced Load Address Table) hardware with software checks to assert invariance. Our approach differs from this by limiting disambiguation hardware to check references only within a RTM region.

Some embodiments provide techniques to be used in a transparent binary optimizer. Such techniques may also be used for compilers, program optimizers, and/or transparent dynamic optimization systems. Also, the analysis proposed herein may be used to optimize generated code dynamically.

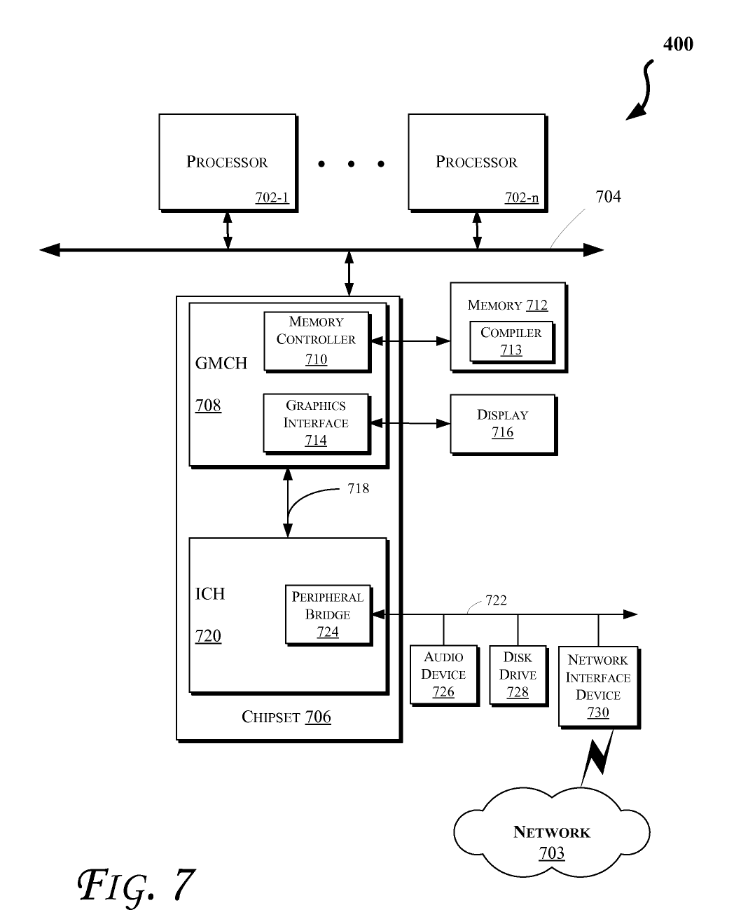

FIG. 7 illustrates a block diagram of an embodiment of a computing system 700. In various embodiments, one or more of the components of the system 700 may be provided in various electronic devices capable of performing one or more of the operations discussed herein with reference to some embodiments of the invention. For example, one or more of the components of the system 700 may be used to perform the operations discussed with reference to FIGS. 1-6, e.g., by processing instructions, executing subroutines, etc. in accordance with the operations discussed herein. Also, various storage devices discussed herein (e.g., with reference to FIGS. 7 and/or 8) may be used to store data, operation results, etc. Furthermore, system 700 may be used in laptops, mobile devices, ultrabooks, tablets, Smartphones, etc.

More particularly, the computing system 700 may include one or more central processing unit(s) (CPUs) 702 or processors that communicate via an interconnection network (or bus) 704. Hence, various operations discussed herein may be performed by a CPU in some embodiments. Moreover, the processors 702 may include a general purpose processor, a network processor (that processes data communicated over a computer network 703), or other types of a processor (including a reduced instruction set computer (RISC) processor or a complex instruction set computer (CISC)). Moreover, the processors 702 may have a single or multiple core design. The processors 702 with a multiple core design may integrate different types of processor cores on the same integrated circuit (IC) die. Also, the processors 702 with a multiple core design may be implemented as symmetrical or asymmetrical multiprocessors. Moreover, the operations discussed with reference to FIGS. 1-6 may be performed by one or more components of the system 700.

A chipset 706 may also communicate with the interconnection network 704. The chipset 706 may include a graphics and memory control hub (GMCH) 708. The GMCH 708 may include a memory controller 710 that communicates with a memory 712. The memory 712 may store data, including sequences of instructions that are executed by the CPU 702, or any other device included in the computing system 700. In an embodiment, the memory 712 may store a compiler 713, which may be the same or similar to the compiler discussed with reference to FIGS. 1-8. Same or at least a portion of this data (including instructions) may be stored in disk drive 728 and/or one or more caches within processors 702. In one embodiment of the invention, the memory 712 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 704, such as multiple CPUs and/or multiple system memories.

The GMCH 708 may also include a graphics interface 714 that communicates with a display 716. In one embodiment of the invention, the graphics interface 714 may communicate with the display 716 via an accelerated graphics port (AGP). In an embodiment of the invention, the display 716 may be a flat panel display that communicates with the graphics interface 714 through, for example, a signal converter that translates a digital representation of an image stored in a storage device such as video memory or system memory into display signals that are interpreted and displayed by the display 716. The display signals produced by the interface 714 may pass through various control devices before being interpreted by and subsequently displayed on the display 716. In some embodiments, the processors 702 and one or more other components (such as the memory controller 710, the graphics interface 714, the GMCH 708, the ICH 720, the peripheral bridge 724, the chipset 706, etc.) may be provided on the same IC die.

A hub interface 718 may allow the GMCH 708 and an input/output control hub (ICH) 720 to communicate. The ICH 720 may provide an interface to I/O devices that communicate with the computing system 700. The ICH 720 may communicate with a bus 722 through a peripheral bridge (or controller) 724, such as a peripheral component interconnect (PCI) bridge, a universal serial bus (USB) controller, or other types of peripheral bridges or controllers. The bridge 724 may provide a data path between the CPU 702 and peripheral devices. Other types of topologies may be utilized. Also, multiple buses may communicate with the ICH 720, e.g., through multiple bridges or controllers. Moreover, other peripherals in communication with the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 722 may communicate with an audio device 726, one or more disk drive(s) 728, and a network interface device 730, which may be in communication with the computer network 703. In an embodiment, the device 730 may be a NIC capable of wireless communication. Other devices may communicate via the bus 722. Also, various components (such as the network interface device 730) may communicate with the GMCH 708 in some embodiments of the invention. In addition, the processor 702, the GMCH 708, and/or the graphics interface 714 may be combined to form a single chip.

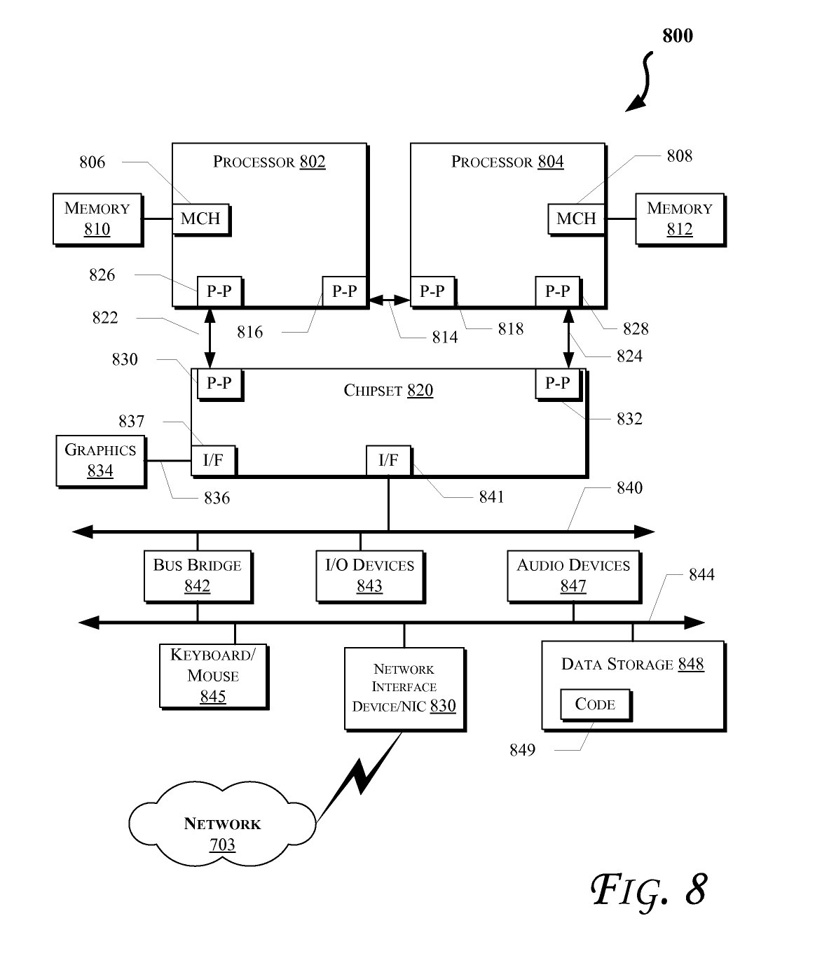

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 700 may be arranged in a point-to-point (PtP) configuration such as discussed with reference to FIG. 8. For example, processors, memory, and/or input/output devices may be interconnected by a number of point-to-point interfaces.

More specifically, FIG. 8 illustrates a computing system 800 that is arranged in a point-to-point (PtP) configuration, according to an embodiment of the invention. In particular, FIG. 8 shows a system where processors, memory, and input/output devices are interconnected by a number of point-to-point interfaces. The operations discussed with reference to FIGS. 1-7 may be performed by one or more components of the system 800.

As illustrated in FIG. 8, the system 800 may include several processors, of which only two, processors 802 and 804 are shown for clarity. The processors 802 and 804 may each include a local memory controller hub (MCH) 806 and 808 (which may be the same or similar to the GMCH 708 of FIG. 7 in some embodiments) to couple with memories 810 and 812. The memories 810 and/or 812 may store various data such as those discussed with reference to the memory 712 of FIG. 7.

The processors 802 and 804 may be any suitable processor such as those discussed with reference to the processors 802 of FIG. 8. The processors 802 and 804 may exchange data via a point-to-point (PtP) interface 814 using PtP interface circuits 816 and 818, respectively. The processors 802 and 804 may each exchange data with a chipset 820 via individual PtP interfaces 822 and 824 using point to point interface circuits 826, 828, 830, and 832. The chipset 820 may also exchange data with a high-performance graphics circuit 834 via a high-performance graphics interface 836, using a PtP interface circuit 837.

At least one embodiment of the invention may be provided by utilizing the processors 802 and 804. For example, the processors 802 and/or 804 may perform one or more of the operations of FIGS. 1-7. Other embodiments of the invention, however, may exist in other circuits, logic units, or devices within the system 800 of FIG. 8. Furthermore, other embodiments of the invention may be distributed throughout several circuits, logic units, or devices illustrated in FIG. 8.

The chipset 820 may be coupled to a bus 840 using a PtP interface circuit 841. The bus 840 may have one or more devices coupled to it, such as a bus bridge 842 and I/O devices 843. Via a bus 844, the bus bridge 843 may be coupled to other devices such as a keyboard/mouse 845, the network interface device 830 discussed with reference to FIG. 8 (such as modems, network interface cards (NICs), or the like that may be coupled to the computer network 703), audio I/O device, and/or a data storage device 848. The data storage device 848 may store code 849 that may be executed by the processors 802 and/or 804.

In various embodiments of the invention, the operations discussed herein, e.g., with reference to FIGS. 1-8, may be implemented as hardware (e.g., logic circuitry), software (including, for example, micro-code that controls the operations of a processor such as the processors discussed herein), firmware, or combinations thereof, which may be provided as a computer program product, e.g., including a tangible (e.g., non-transitory) machine-readable or computer-readable medium having stored thereon instructions (or software procedures) used to program a computer (e.g., a processor or other logic of a computing device) to perform an operation discussed herein. The machine-readable medium may include a storage device such as those discussed herein.

In some embodiments, an apparatus (e.g., a processor) or system includes: logic to analyze an input code to determine one or more memory locations to be accessed by the input program; and logic to generate an output code based on the input code and one or more assumptions about invariance of the one or more memory locations, where the output code is to be generated based on hardware transactional memory support and hardware dynamic disambiguation support. The one or more assumptions may be one or more of: a limit of a loop in the input code is invariant: a base address of a memory access, corresponding to the one or more memory locations, is invariant; and the one or more memory locations used in indirections are invariant within a restricted transactional memory region. The hardware transactional memory support may ensure that individual loop iterations of the input code are executed atomically. The hardware dynamic disambiguation support may verify one or more checks of the output code to ensure invariance of the one or more memory locations. The hardware transactional memory support may ensure that individual loop iterations of the input code are executed atomically, and the hardware dynamic disambiguation support may verify one or more checks of the output code to ensure invariance of the one or more memory locations. The apparatus may also include logic to roll back an atomic region in response to failure of any of the one or more checks. The hardware transactional memory support may be based on transactional synchronization extensions. The logic to generate the output code may include binary optimizer logic. One or more of the input code and the output code may include a loop or a loop-nest. The loop or loop-nest may include one or more loop iterations within one or more restricted transaction memory regions of a memory coupled to a processor. The apparatus may also include logic to perform one or more checks of the output code to ensure invariance of the one or more memory locations across one or more of the one or more loop iterations. The one or more loop iterations may be adjacent. An entire loop may execute in a plurality of restricted transaction memory regions. The plurality of restricted transaction memory regions may be adjacent.

In some embodiments, a method includes: analyzing an input code to determine one or more memory locations to be accessed by the input program; and generating an output code based on the input code and one or more assumptions about invariance of the one or more memory locations, where the output code is to be generated based on hardware transactional memory support and hardware dynamic disambiguation support. The one or more assumptions may be one or more of: a limit of a loop in the input code is invariant: a base address of a memory access, corresponding to the one or more memory locations, is invariant; and the one or more memory locations used in indirections are invariant within a restricted transactional memory region. The hardware transactional memory support may ensure that individual loop iterations of the input code are executed atomically. The hardware dynamic disambiguation support may verify one or more checks of the output code to ensure invariance of the one or more memory locations. An atomic region may be rolled back in response to failure of any of the one or more checks. The hardware transactional memory support may be based on transactional synchronization extensions. One or more of the input code and the output code may include a loop or a loop-nest.

In some embodiments, a computer-readable medium includes one or more instructions that when executed on a processor configure the processor to perform one or more operations to: analyze an input code to determine one or more memory locations to be accessed by the input program; and generate an output code based on the input code and one or more assumptions about invariance of the one or more memory locations, where the output code is to be generated based on hardware transactional memory support and hardware dynamic disambiguation support. The one or more assumptions may be one or more of: a limit of a loop in the input code is invariant: a base address of a memory access, corresponding to the one or more memory locations, is invariant; and the one or more memory locations used in indirections are invariant within a restricted transactional memory region. The hardware transactional memory support may ensure that individual loop iterations of the input code are executed atomically. The hardware dynamic disambiguation support may verify one or more checks of the output code to ensure invariance of the one or more memory locations. The computer-readable medium may include one or more instructions that when executed on the processor configure the processor to perform one or more operations to roll back an atomic region in response to failure of any of the one or more checks. The hardware transactional memory support may be provided based on transactional synchronization extensions. One or more of the input code and the output code are to may include a loop or a loop-nest. The loop or loop-nest may include one or more loop iterations within one or more restricted transaction memory regions of a memory. The computer-readable medium may include one or more instructions that when executed on the processor configure the processor to perform one or more operations to perform one or more checks of the output code to ensure invariance of the one or more memory locations across one or more of the one or more loop iterations. The computer-readable medium may include one or more instructions that when executed on the processor configure the processor to perform one or more operations to execute an entire loop in a plurality of restricted transaction memory regions.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, e.g., through a carrier wave or other propagation medium, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
logic to analyze an input code to determine one or more memory locations to be accessed by the input program; and
logic to generate an output code based on the input code and one or more assumptions about invariance of the one or more memory locations,
wherein the output code is to be generated based on hardware transactional memory support and hardware dynamic disambiguation support.

2. The processor of claim 1, wherein the one or more assumptions is one or more of: a limit of a loop in the input code is invariant: a base address of a memory access, corresponding to the one or more memory locations, is invariant; and the one or more memory locations used in indirections are invariant within a restricted transactional memory region.

3. The processor of claim 1, wherein the hardware transactional memory support is to ensure that individual loop iterations of the input code are executed atomically.

4. The processor of claim 1, wherein the hardware dynamic disambiguation support is to verify one or more checks of the output code to ensure invariance of the one or more memory locations.

5. The processor of claim 1, wherein:
the hardware transactional memory support is to ensure that individual loop iterations of the input code are executed atomically;
the hardware dynamic disambiguation support is to verify one or more checks of the output code to ensure invariance of the one or more memory locations; and
logic to roll back an atomic region in response to failure of any of the one or more checks.

6. The processor of claim 1, wherein the hardware transactional memory support is to be based on transactional synchronization extensions.

7. The processor of claim 1, wherein the logic to generate the output code is to comprise binary optimizer logic.

8. The processor of claim 1, wherein one or more of the input code and the output code are to comprise a loop or a loop-nest.

9. The processor of claim 8, wherein the loop or loop-nest are to comprise one or more loop iterations within one or more restricted transaction memory regions of a memory coupled to the processor.

10. The processor of claim 9, further comprising logic to perform one or more checks of the output code to ensure invariance of the one or more memory locations across one or more of the one or more loop iterations.

11. The processor of claim 9, wherein the one or more loop iterations are adjacent.

12. The processor of claim 8, wherein an entire loop is to execute in a plurality of restricted transaction memory regions.

13. The processor of claim 12, wherein the plurality of restricted transaction memory regions are adjacent.

14. A method comprising:
analyzing an input code to determine one or more memory locations to be accessed by the input program; and
generating an output code based on the input code and one or more assumptions about invariance of the one or more memory locations,
wherein the output code is to be generated based on hardware transactional memory support and hardware dynamic disambiguation support.

15. The method of claim 14, wherein the one or more assumptions is one or more of: a limit of a loop in the input code is invariant: a base address of a memory access, corresponding to the one or more memory locations, is invariant; and the one or more memory locations used in indirections are invariant within a restricted transactional memory region.

16. The method of claim 14, further comprising the hardware transactional memory support ensuring that individual loop iterations of the input code are executed atomically.

17. The method of claim 14, further comprising the hardware dynamic disambiguation support verifying one or more checks of the output code to ensure invariance of the one or more memory locations.

18. The method of claim 17, further comprising rolling back an atomic region in response to failure of any of the one or more checks.

19. The method of claim 14, further comprising providing the hardware transactional memory support based on transactional synchronization extensions.

20. The method of claim 14, wherein one or more of the input code and the output code comprise a loop or a loop-nest.

21. A computer-readable medium comprising one or more instructions that when executed on a processor configure the processor to perform one or more operations to:
analyze an input code to determine one or more memory locations to be accessed by the input program; and
generate an output code based on the input code and one or more assumptions about invariance of the one or more memory locations,
wherein the output code is to be generated based on hardware transactional memory support and hardware dynamic disambiguation support.

22. The computer-readable medium of claim 21, wherein the one or more assumptions is one or more of: a limit of a loop in the input code is invariant: a base address of a memory access, corresponding to the one or more memory locations, is invariant; and the one or more memory locations used in indirections are invariant within a restricted transactional memory region.

23. The computer-readable medium of claim 21, wherein the hardware transactional memory support is to ensure that individual loop iterations of the input code are executed atomically.

24. The computer-readable medium of claim 21, wherein the hardware dynamic disambiguation support is to verify one or more checks of the output code to ensure invariance of the one or more memory locations.

25. The computer-readable medium of claim 24, further comprising one or more instructions that when executed on the processor configure the processor to perform one or more operations to roll back an atomic region in response to failure of any of the one or more checks.

26. The computer-readable medium of claim 21, wherein the hardware transactional memory support is to be provided based on transactional synchronization extensions.

27. The computer-readable medium of claim 21, wherein one or more of the input code and the output code are to comprise a loop or a loop-nest.

28. The computer-readable medium of claim 27, wherein the loop or loop-nest is to comprise one or more loop iterations within one or more restricted transaction memory regions of a memory.

29. The computer-readable medium of claim 28, further comprising one or more instructions that when executed on the processor configure the processor to perform one or more operations to perform one or more checks of the output code to ensure invariance of the one or more memory locations across one or more of the one or more loop iterations.

30. The computer-readable medium of claim 21, further comprising one or more instructions that when executed on the processor configure the processor to perform one or more operations to execute an entire loop in a plurality of restricted transaction memory regions.
